(19) United States
(12) Patent Application Publication
(10) Pub. No.: US 2003/0162534 A1
(43) Pub. Date: Aug. 28, 2003

(54) Method of informing a status condition of a mobile phone and providing a service control center

(75) Inventor: I-Yang Lee, Taipei (TW)

Correspondence Address: BACON & THOMAS, PLLC, 625 SLATERS LANE, FOURTH FLOOR, ALEXANDRIA, VA, 22314

(73) Assignee: Institute For Information Industry, Taipei (TW)

(21) Appl. No.: 10/083,135

(22) Filed: Feb. 27, 2002

(51) Int. Cl. H04M 3/00

(52) U.S. Cl. 455/420; 455/418; 455/419; 455/560

(57) ABSTRACT

A control center of the present invention includes a communication system and a computer system. The communication system is used for receiving and sending signals, and the computer system is linked to the communication system and used for executing necessary software. The computer system has a status database, a status monitoring program module, and a status notification program module. The status monitoring program module is used for monitoring the status condition of every mobile phone, and to perform different procedures under different status conditions. In the preferred embodiment, when one of the users changes the status of the predetermined mobile phone, the control center updates the status database and informs the associated mobile phones, which have set the predetermined mobile phone as a contact. Furthermore, when the status condition of any of the associated mobile phones has changed, the control center informs the predetermined mobile phone.

### BACKGROUND OF THE INVENTION

1. Field of the Invention

The present invention relates to a method of providing information about a status condition of a predetermined mobile phone.

2. Description of Related Art

In the conventional second generation European standard GSM or GPRS, or third generation communication systems, after a predetermined mobile phone is switched on, a user can select a number for a mobile phone from the predetermined mobile phone, but the user is unable to know if the selected mobile phone is on or busy. Consequently, the user must dial the selected number to get the status condition (on status, off status or busy status) of the selected mobile phone. For example, when the selected mobile phone is busy, the user will frequently need to re-dial several times to connect to the selected mobile phone. The user wastes a great deal of time in this manner, while occupying wireless network resources and consuming battery power..

### SUMMARY OF THE INVENTION

The object of the present invention is to provide a status condition of a selected mobile phone to a user without requiring the making of a phone call. For example, the user can decide whether to make a call to a mobile phone, to wait, or to call his office phone instead, etc. according to the status condition of the selected mobile phone. The user can also send a short message through the network.

To achieve the object, a control center of the present invention includes a communication system and a computer system. The communication system is used for receiving and sending signals, and the computer system is linked to the communication system and used for executing necessary software. The computer system has a status database, a status monitoring program module, and a status notification program module.

The status monitoring program module is used for monitoring the status condition of every mobile phone, and to perform different procedures under different status conditions. In the preferred embodiment, Ad when one of the users changes the status of the predetermined mobile phone, the control center updates the status database and informs the associated mobile phones, which have set the predetermined mobile phone as a contact. Furthermore, when the status condition of any of the associated mobile phones has changed, the control center informs the predetermined mobile phone.

Other objects, advantages, and novel features of the invention will become more apparent from the following detailed description when taken in conjunction with the accompanying drawings.

### BRIEF DESCRIPTION OF THE DRAWINGS

FIG. 1 is a schematic drawing of the environment of the present invention.

FIG. 2 is a schematic drawing of a control center of the present invention.

FIG. 3 is an embodiment of a status database of the present invention.

FIG. 4 is a flowchart of the present invention.

FIG. 5 is a screen display of a mobile phone of the present invention.

### DETAILED DESCRIPTION OF THE PREFERRED EMBODIMENT

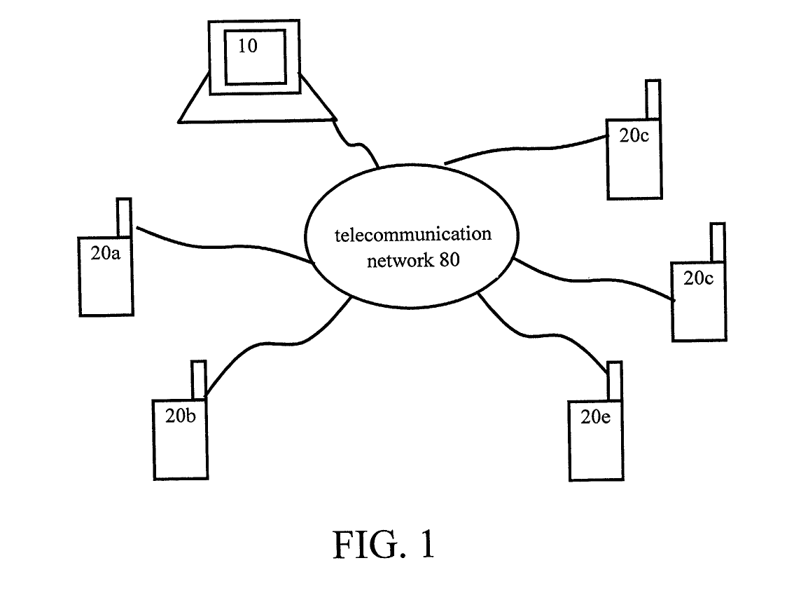

Please refer to FIG. 1. FIG. 1 is a schematic drawing of the environment of the present invention. Mobile phones 20a-20e are linked to each other via a telecommunication network 80. The telecommunication network 80 may comprise many base stations, controllers, wired or wireless transmission devices, and even other telecommunication networks. In addition, the telecommunication network 80 comprises at least one control center 10. The control center 10 integrates connections among different base stations and records data about the mobile phones 20a-20e.

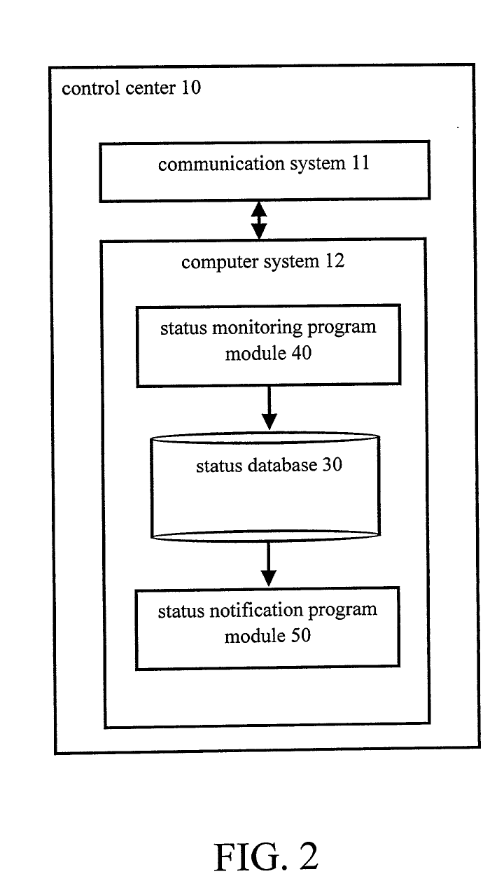

Please refer to FIG. 2. FIG. 2 is a schematic drawing of a control center of the present invention. The control center 10 comprises a communication system 11 and a computer system 12. The communication system 11 is used for receiving and sending signals, and the computer system 12 is linked to the communication system 12 and executes necessary software. In the embodiment of the present invention, the computer system 12 includes a status database 30, a status monitoring program module 40 and a status notification program module 50.

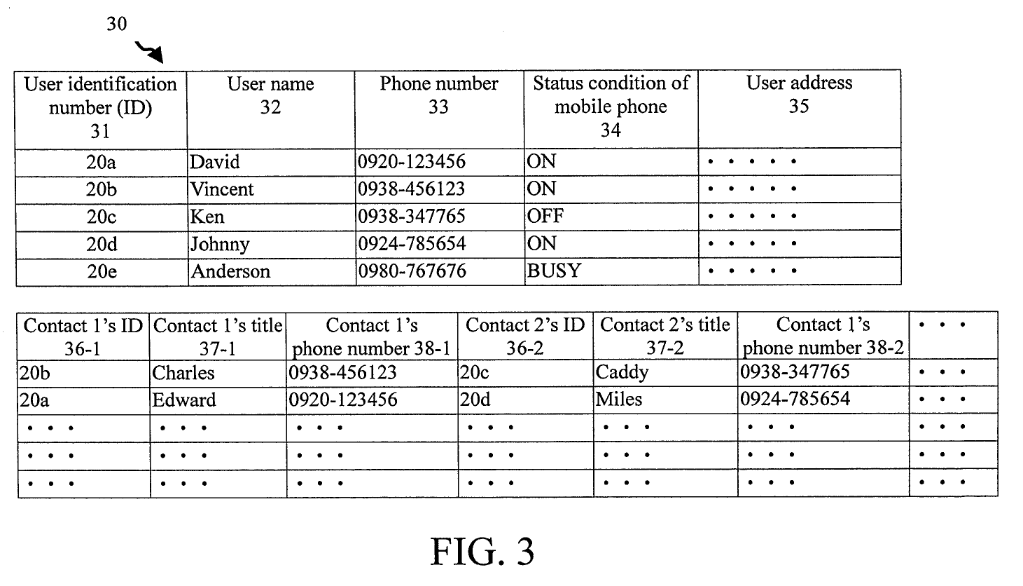

Please refer to FIG. 3. FIG. 3 is an embodiment of a status database 30 of the present invention. The following description explains the meaning of each column in the status database 30:

User identification number 31, which usually exists in the mobile phone communication system, is a unique user identification number for each phone number.

User name 32, records the name of the associated mobile phone, usually is a person's name or a company name.

Phone number 33, records the phone number of the associated mobile phone.

Status condition of contact's mobile phone 34, is the characteristic of present invention. In the embodiment, the status condition of the mobile phone includes an on status, an off status and a busy status; for example, the mobile phone 20a is on status. The status condition can be changed with the present status.

User address 35, records a registration address of the user.

Contact identification number 36, is a number for each contact input by the user. The idea of “contact” is the characteristic of the present invention, the user can input a plurality of contacts which are usually user's family or friends. In the embodiment of the present invention, the contacts of the mobile phone 20a are mobile phone 20b and mobile phone 20c, and the user of mobile phone 20b selects the user of mobile phone 20a as a contact.

Contact title 37, inputted by the user of mobile phone, is usually contact name, contracted name, English name, nickname etc. For example, the user of the mobile phone 20a input “Charles” as a title for the user of mobile phone 20b.

Contact phone number 38, inputted by the user of mobile phone.

The input manner for the above-mentioned contact title 37 and contact phone number 38 is alike the input manner for the phonebook of the mobile phone. The user input the data in the mobile phone, the mobile phone then sends the data to the control center 10 for recording. Since the phone number is unique, the user identification number 31 and the contact identification number 36 are not necessary.

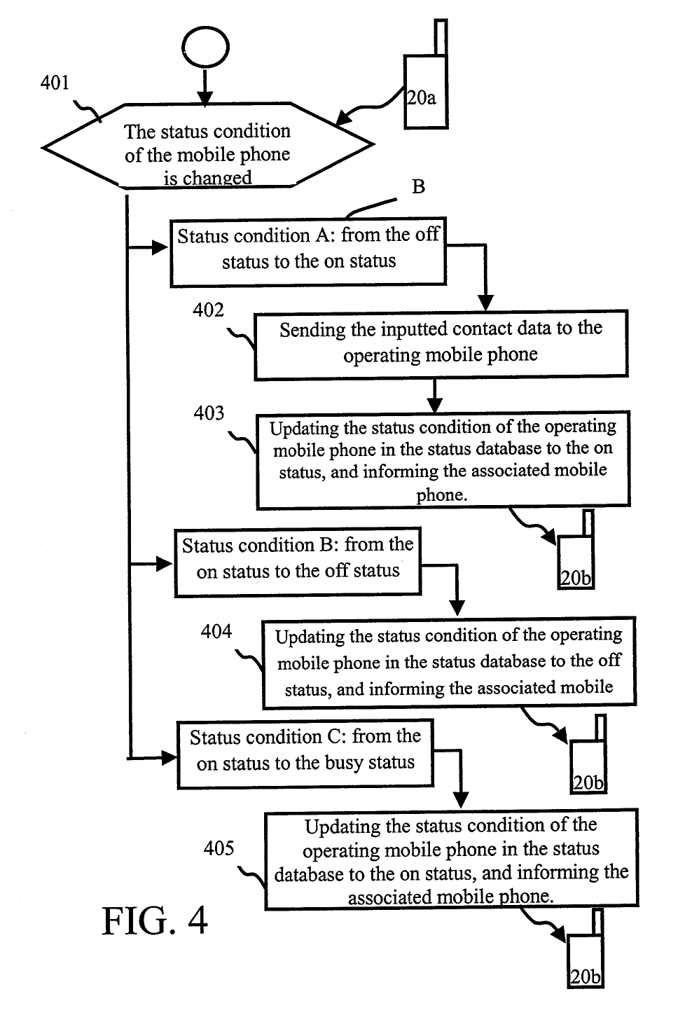

Please refer to FIG. 4, and FIG. 2 again. FIG. 4 is a flowchart of the present invention. The flow is about the control center 10 processes status condition change of mobile phone. There are three status conditions of the mobile phone: condition A—from off status switched to on status; condition B—from on status switched to off status; and condition C—from on status switched to busy status.

Step 401:

The control center 10 judges the status condition for the mobile phone 20a. The connection between the control center 10 and the mobile phone is kept periodically according to the wireless communication protocol, so the control center can track status condition of every mobile phone. For example, when the user makes the mobile phone detach from the control center 10, or the signal is too weak to be received by the control center 10, the control center 10 will judge the mobile phone is off (or out of reach). Therefore, when the status condition is changed, the control center 10 will obtain through the status monitoring program module 40. The status monitoring program module 40 monitors status condition change of the mobile phone and processes different procedures according to different status conditions (which are status conditions A, B and C). In the embodiment, the mobile phone 20a is the operating mobile phone, the user of the mobile phone 20a inputs the users of mobile phones 20b, 20c, and 20d as contacts; the user of mobile phone 20 inputs the user of mobile phone 20a as a contact.

Status Condition A: When the Operating Mobile Phone is Switched from the Off Status to the On Status:

Step 402:

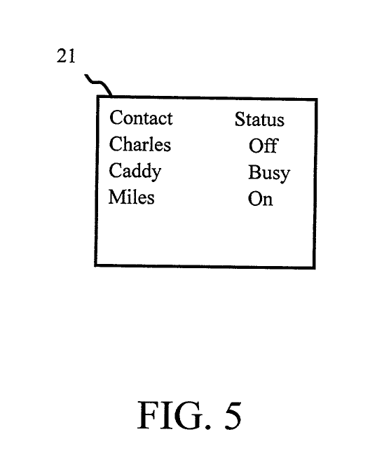

The control center 10 sends the inputted contact data to the operating mobile phone, the inputted contact data comprises a contact title 37, a contact mobile phone number 38, and the status condition of contact's mobile phone 34. For example, if the user of mobile phone 20a wants to see the status condition of contact's mobile phone, the screen 21 of the mobile phone 20a will show the contact title 37 and the status condition of contact's mobile phone 34 of mobile phone 20b, 20c and 20d as shown in FIG. 5.

Step 403:

The control center 10 updates the status condition of the operating mobile phone in the status database 30 to the on status.

Furthermore, the status notification program module 50 informs the status condition of operating mobile phone to the associated mobile phone, which is the mobile phone 20b.

Status B: When the Operating Mobile Phone is Switched from On Status to Off Status:

Step 404:

The control center 10 updates the status condition of the operating mobile phone in the status database 30 to the off status.

Furthermore, the status notification program module 50 informs the status condition of operating mobile phone to the associated mobile phone, which is the mobile phone 20b.

Status C: When the Mobile Phone is Switched from the On Status to the Busy Status:

Step 405:

The control center 10 updates the status condition of the operating mobile phone in the status database 30 to the busy status. Furthermore, the status notification program module 50 informs the status condition of operating mobile phone to the associated mobile phone, which is the mobile phone 20b.

In the above-mentioned step 403, step 404 and step 405, the control center 10 will not inform the associated mobile phone which is switched to off status. For example, the users of the mobile phone 20b and 20c both input the user of mobile phone 20a as a contact, wherein the mobile phone 20b is on status and the mobile phone 20c is off status. When the status condition of mobile phone 20a is changed, only the mobile phone 20b will be informed not the mobile phone 20c.

The invention has been described using exemplary preferred embodiments. However, for those skilled in this field the preferred embodiments can be easily adapted and modified to suit additional applications without departing from the spirit and scope of this invention. Thus, it is to be understood that the scope of the invention is not limited to the disclosed embodiments. On the contrary, it is intended to cover various modifications and similar arrangements based upon the same operating principle. The scope of the claims, therefore, should be accorded the broadest interpretations so as to encompass all such modifications and similar arrangements.

Although the present invention has been explained in relation to its preferred embodiment, it is to be understood that many other possible modifications and variations can be made without departing from the spirit and scope of the invention as hereinafter claimed.

What is claimed is:

1. A method of informing of a status condition of a predetermined mobile phone, a control center informing at least one associated mobile phone setting the predetermined mobile phone as a contact, the control center comprising a status database for recording the status condition of every mobile phone and inputted contact data, the status condition of each mobile phone including at least an on status, an off status, the method comprising:
when the predetermined mobile phone is switched from the off status to the on status:
(A) the control center sends the inputted contact data to the predetermined mobile phone, the inputted contact data comprising a contact title, a contact mobile phone number, and at least a portion of the status condition of the associated mobile phone; and
(B) the control center updating the status condition of the predetermined mobile phone in the status database to the on status, and informing the associated mobile phone;
when the mobile phone is switched from the on status to the off status:
(C) the control center updating the status condition of the predetermined mobile phone in the status database to the off status, and informing the associated mobile phone.

2. The method as claimed in claim 1, wherein the status condition of the predetermined mobile phone stored in the status database further comprises a busy status, and the method further comprises:
when the mobile phone is switched from the on status to the busy status:
(D) the control center updating the status condition of the predetermined mobile phone in the status database to the busy status, and informing the associated mobile phone.

3. The method as claimed in claim 1, wherein in the steps (B) and (C), the control center does not inform the associated mobile phone when the associated mobile phone has the off status.

4. The method as claimed in claim 2, wherein in the step (D), the control center does not inform the associated mobile phone when the associated mobile phone has the off status.

5. A mobile phone service control center comprising:
a communication system for receiving and sending signals;
a computer system linked to the communication system, the computer system comprising:
a status database for recording a status condition of every mobile phone, the status condition of each mobile phone including at least an on status, an off status, and inputted contact data;
a status monitoring program module for monitoring the status condition of every mobile phone and accordingly updating the status database when the status condition of a mobile phone changes; and
a status notification program module for informing at least one associated mobile phone when the status condition of a predetermined mobile phone changes.

6. The service control center claimed in claim 1, wherein the status condition of each mobile phone stored in the status database further comprises a busy status.
